(19) United States
(12) Patent Application Publication
(10) Pub. No.: US 2011/0230321 A1
(43) Pub. Date: Sep. 22, 2011

(54) METHOD AND DEVICE FOR PRODUCING CONTAINER-LIKE COMPOSITE PACKAGINGS

(75) Inventors: Ulrich Alef, Wegberg (DE); Kurt Dahlmanns, Gangelt (DE); Michael Eccarius, Linnich (DE)

(73) Assignee: SIG TECHNOLOGY AG, Neuhausen Am Rheinfall (CH)

(21) Appl. No.: 13/131,451

(22) PCT Filed: Sep. 18, 2009
(86) PCT No.: PCT/DE09/01336

§ 371 Date: May 26, 2011

(30) Foreign Application Priority Data
Nov. 28, 2008 (DE) 10 2008 061 005.4
Jun. 4, 2009 (DE) 10 2009 024 365.8

(51) Int. Cl. B31B 1/14

(52) U.S. Cl. 493/56

(57) ABSTRACT

The invention relates to a method and device for producing container-like composite packagings. A web-type material made of a composite that contains at least one layer of cardboard and at least one layer of plastic is folded, provided with a sealing seam and separated into sections, each forming a container. The sealing seam is produced prior to the separation of the web-type material into individual sections.

The invention pertains to a method for producing container-like packagings, in which a web material consisting of a laminate which contains at least one layer of cardboard and at least one layer of a plastic is folded, provided with a sealing seam, and cut into sections suitable for forming the desired type of container.

The invention also pertains to a device for producing container-like laminated packagings, which comprises a transport mechanism for a web material consisting of a laminate containing at least one layer of cardboard and at least one layer of a plastic, and which comprises at least one folding mechanism for the web material, at least one sealing mechanism for producing a sealing seam, and at least one cutting mechanism for dividing the web material into individual sections suitable for forming the desired type of container.

In one embodiment, these types of laminated packagings are used, for example, as cartons to hold liquid food products. A significant area of application consists in the packaging of milk or fruit juices, for example. According to other application examples, food products such as soups, sauces, and vegetables are packaged. There are also applications in which chunky products containing solid pieces are packaged. Applications can thus pertain to pourable, loose, or pasty products.

With respect to the production of these types of laminated packagings and the performance of the filling operation, there are essentially two known methods. According to one method, a prepared web material is sent to a device which not only produces the containers but also performs the filling operation, and all of the individual steps of the process are carried out in this device. The performance of all the processes in combination in this way offers cost advantages but leads to an extremely complicated device, which tends to break down frequently.

According to another embodiment, semi-finished products which have already been folded and provided with a longitudinal seam are produced for the packagings; these products are still open at what will be the bottom and also in the area of what will be the top of the later package. They are folded flat and can be transported in this way to the filling machine. The semi-finished products have already been provided with their final printing on the outside and possibly provided with pouring spouts. In the area of the filling machine, the bottom area is usually closed first by a transverse seam, and then the container is filled with the desired content. The top end of the container is then sealed in the form of a gable, for example, or in the form of a flat gable, or possibly with the use of a flap-type or screw-cap closure.

The production of the semi-finished products for the packaging and the set-up of the filling machine can be done at separate locations and possibly carried out at a considerable distance from each other. In particular, it is possible for the semi-finished products to be produced by the packaging manufacturer and for the packages to be filled by the product manufacturer.

The semi-finished products for the packaging are produced by first printing the outside surface of a web material, which is stored in the form of rolls, then by creasing or folding the material, and finally by cutting it into individual sections. Next, the individual sections are folded and provided with a longitudinal seam, which extends from the area which will become the bottom of the later package up to the top end of the later package. The longitudinal seam is often produced by the welding of plastic areas of the laminated packaging. After these individual semi-finished products for the packaging have been produced, the semi-finished products are stacked and carried away in predefined groups.

The semi-finished products for the packaging are produced at extremely high speed to achieve high outputs per unit time. In a preceding step of the process, i.e., the first step, which has not yet been mentioned, the webs of starting material for the laminated packaging are produced from webs of cardboard and with the use of metal foils in conjunction with the application of coatings of a plastic such as polyethylene. These steps can be conducted as continuous processes at very high transport speeds.

It has now been found that any further increase in production speed is limited in particular by the process step of folding the blanks of material and by the application of the sealing seams extending in the longitudinal direction. Although optimizations of certain details have been able to achieve significant advances in processing, it has not been possible to fulfill all of the requirements which are to be imposed on trouble-free, reliable, and economical production.

The goal of the present invention is therefore to improve a method of the type described above in such a way that increased production speeds are made possible.

This goal is achieved according to the invention in that the sealing seam is produced before the web material is cut into individual sections.

An additional goal of the present invention is to construct a device of the type indicated above in such a way that an increase in production speed is achieved.

This goal is achieved according to the invention in that the sealing mechanism is installed upstream of the cutting mechanism with respect to the transport direction of the web material.

Reversing the order in which the prior art carries out the two process steps, that is, producing the sealing seam first and only then cutting the web material into individual sections, leads to significant advantages over the prior art. Both the folding operation preceding the sealing and the production of the sealing seam itself can be conducted as a continuous process during the continuous movement of the material to be processed. This makes it possible to transport the material at a much higher speed through the overall process and thus drastically reduces the process times. Because the process steps in question are executed continuously, it is also possible to keep the associated process parameters constant easily and with extremely high accuracy. This means that the process can be executed on a very high quality level and thus, for a given product quality, it is possible to achieve a further increase in production speed.

A preferred application consists in the production of blanks or casings for containers intended for the aseptic packaging of products, especially food products.

For the preparation of the fold lines, it has also been found effective first to groove the web material where the fold lines are to be formed.

It is also provided that the web material will be folded.

A typical application consists in that the folding and sealing are carried out in such a way as to provide a container with an essentially rectangular cross-section. In principle, any other cross-sectional shapes are also possible, such as triangular, polygonal, or rounded.

Melting certain plastic areas of the web material makes it easier to produce the sealing seams. For the production of aseptic sealing seams, care must be taken to ensure that the product cannot come in contact with the exposed cut edges.

According to a simplified embodiment, the sealing seam is produced after the web material has been folded and after the folded structure has been collapsed into a flat, tube-like formation.

An alternative production variant consists in that the sealing seam is produced after the web material has been folded around an interior space.

Exemplary embodiments of the invention are illustrated schematically in the drawings:

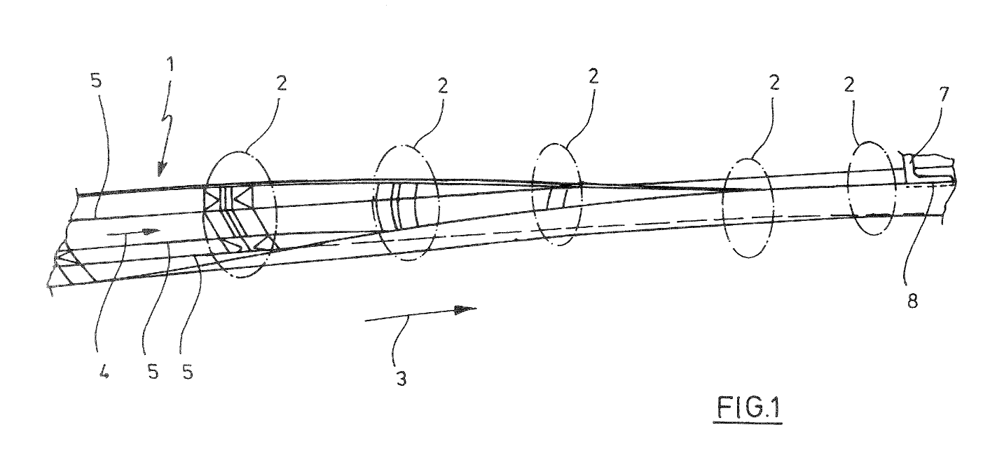

FIG. 1 shows a perspective view illustrating a folding operation for converting a web of flat material into a folded, tube-like formation;

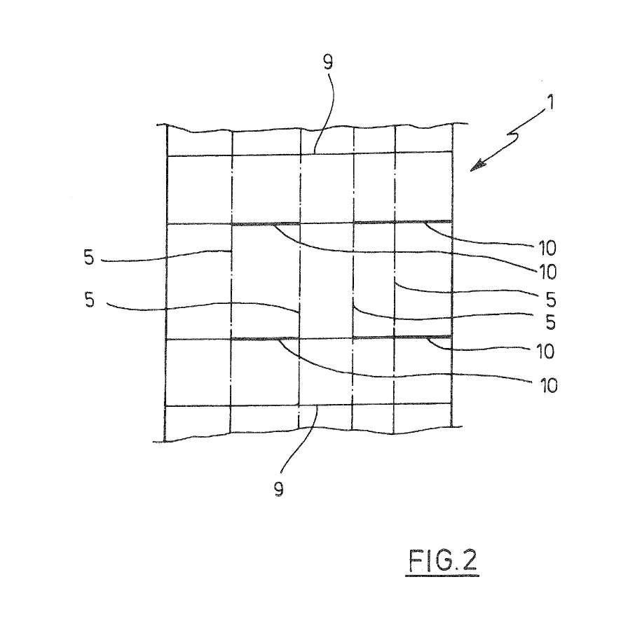

FIG. 2 shows a schematic diagram illustrating the fold lines on an area of a blank for a container;

FIG. 3 shows a schematic side view of the part of the system for performing a grooving and stamping operation in preparation for the folding of the material;

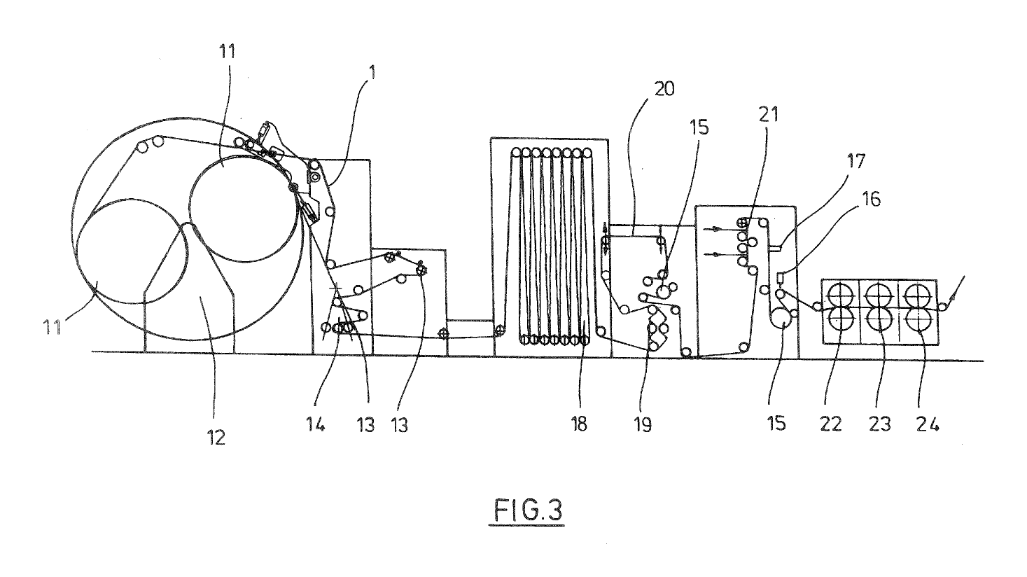

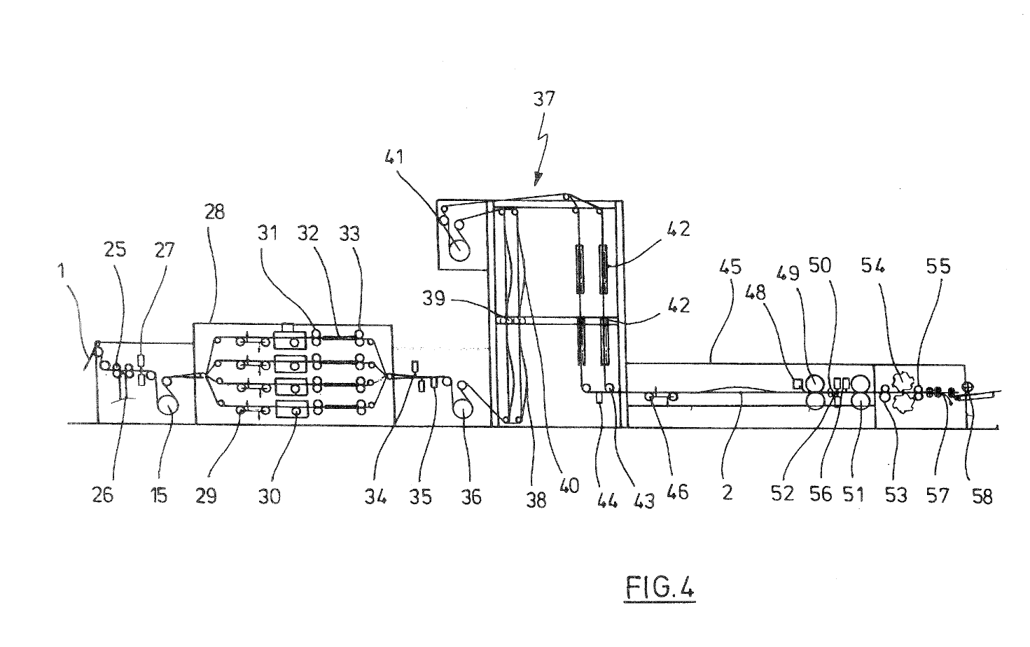

FIG. 4 shows a schematic side view of the part of the system for dividing a wide web into individual webs, for prefolding and finish-folding, and finally for producing a sealing seam extending in a longitudinal direction;

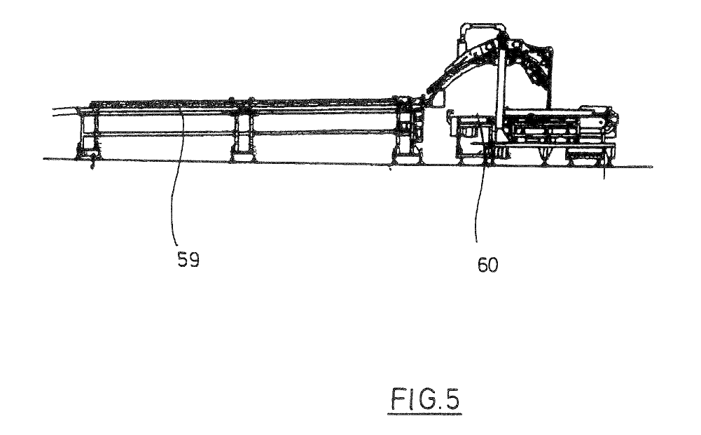

FIG. 5 shows a schematic side view of the part of the system for transporting container blanks away;

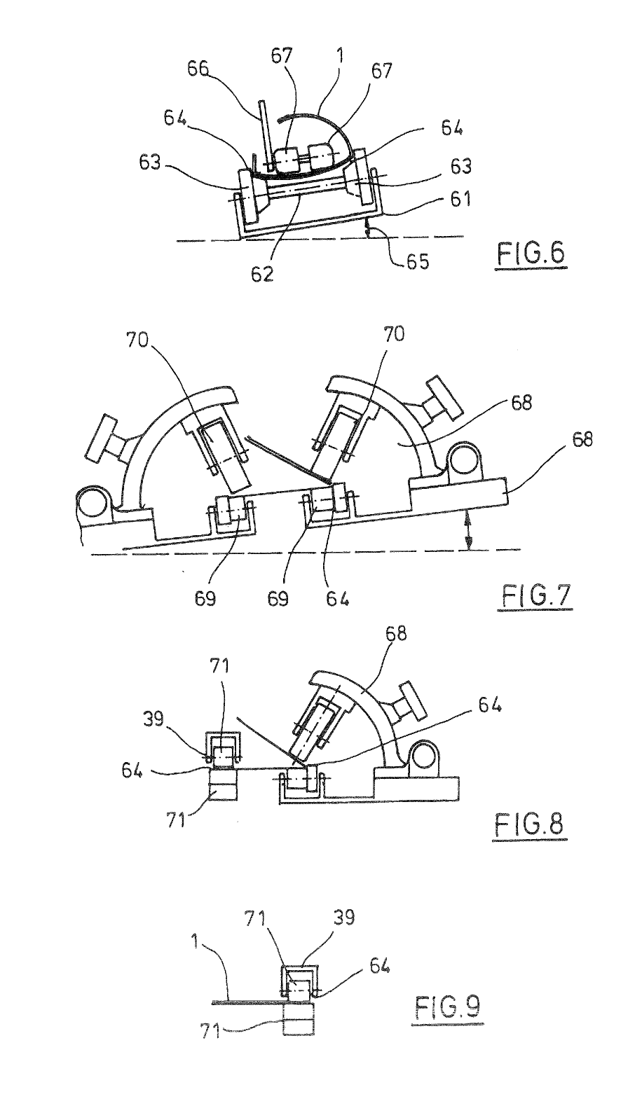

FIG. 6 shows a first working position in the area where the web material is prefolded;

FIG. 7 shows an illustration of a process step following that of FIG. 6;

FIG. 8 shows a continuation of the step of the method according to FIG. 7;

FIG. 9 shows the conclusion of the prefolding operation;

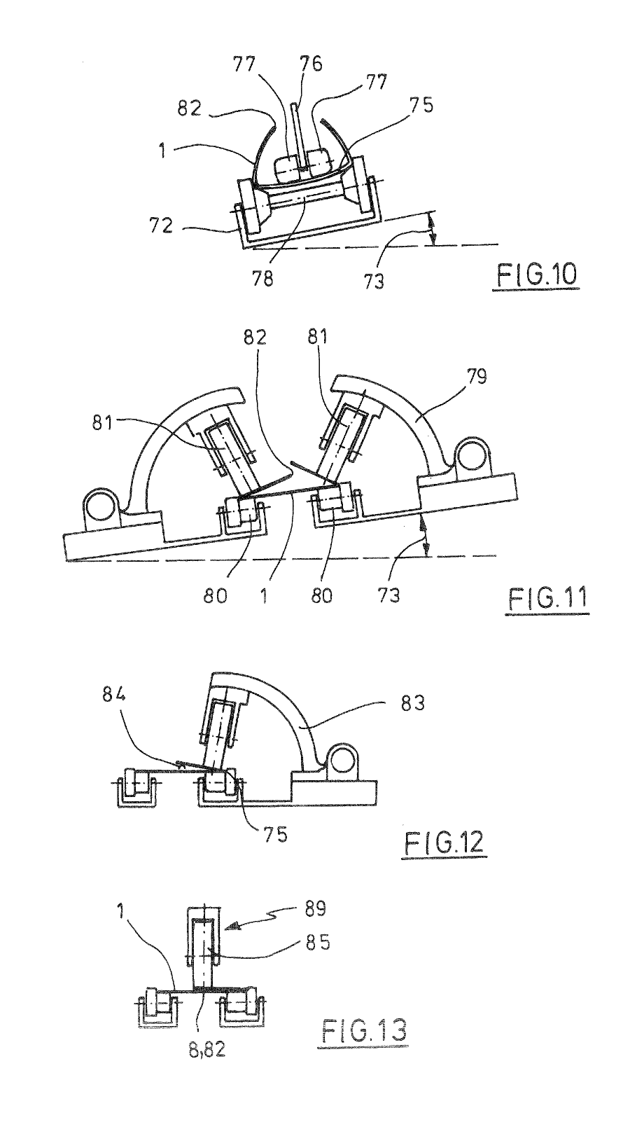

FIG. 10 shows the first step of the finish-folding process;

FIG. 11 shows the second step of the finish-folding process after the step according to FIG. 10;

FIG. 12 shows a further continuation of the step according to FIG. 11;

FIG. 13 shows the concluding step of the finish-folding process;

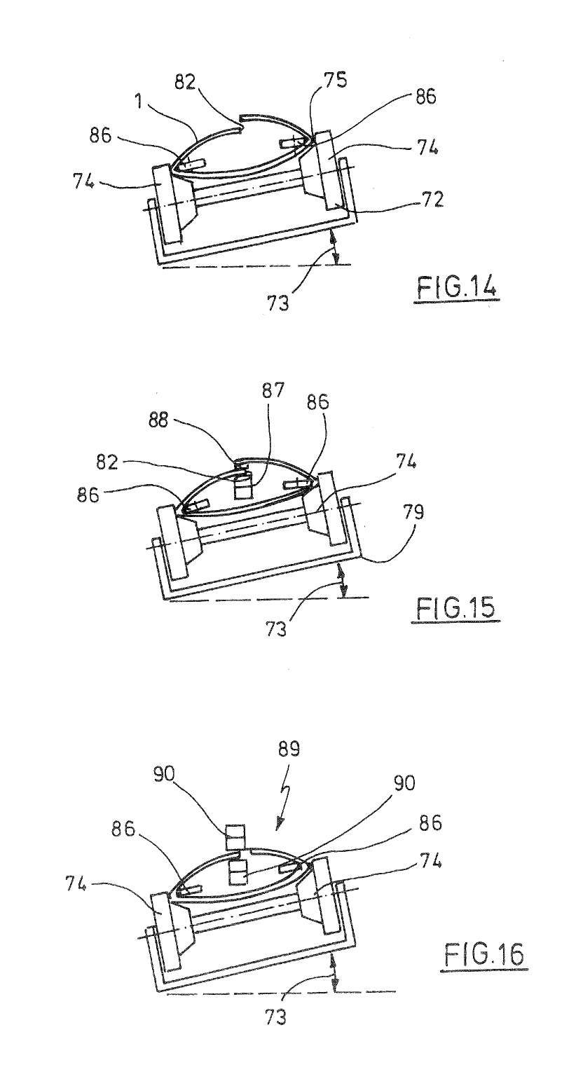

FIG. 14 shows another embodiment of a first step of the finish-folding process;

FIG. 15 shows a continuation of the process begun in FIG. 14; and

FIG. 16 shows the concluding step of the finish-folding process according to FIGS. 14 and 15.

FIG. 1 shows a schematic diagram which illustrates the basic principle of the invention. A web material 1 is conveyed along guide elements 2 in a transport direction 3. The transport direction 3 corresponds in this case to the longitudinal direction 4 of the web material 1. In the longitudinal direction 4, the web material 1 comprises lines 5 along which the material has been weakened. The weakened lines 5 of material can be produced, for example, by grooving, by removal of material, by perforation, or by thermal treatment. For the production of rectangular box-like containers, typically four weakened lines 5 of material are produced to facilitate the folding of the web material 1 along the weakened lines 5 and to specify exactly where the fold lines are to be located. More or fewer fold lines will be used for other cross-sectional geometries.

The guide elements 2 have the job of defining the folding of the web material 1 around the weakened lines 5 of material and to execute that operation in a controlled manner. In the simplest case, the guide elements 2 consist of rails, along which the web material 1 is guided. To avoid losses through friction, a special concept of the invention is to arrange the linear forming means which act on the web material 1 in the area of the guide elements 2.

In the transport direction 3, a plurality of guide elements 2 is typically arranged in a row a certain distance apart from each other. To facilitate a continuous folding operation, the linear forming means are positioned in the area of the guide elements 2 in such a way that the degree of progress of the folding operation increases step by step in the transport direction 3. As a result of the linear forming operation, a tube-like, folded material is obtained, which is configured 3-dimensionally in such a way that it encloses an inner cross-sectional area or which is folded so that the walls of the tube lie flat on each other.

Upon completion of the linear forming step of the web material 1, which has been folded into a basic tube-like contour, the cross-sectional surface transverse to the longitudinal direction 4 will be bounded by straight wall sections. Typically, a cross-sectional surface of this type will be rectangular.

Upon completion of the linear forming step, a sealing seam 8 extending in the transport direction 3 is produced in the area of a sealing mechanism 7. The sealing seam 8 can be produced by welding together certain plastic areas present in the web material 1, for example. It is also possible to supply separately materials suitable for a welding operation or to produce the sealing seam 8 by bonding with an adhesive.

With respect to the web material 1, there are many different possibilities which can be used. For the production of laminated packaging, appropriate laminated material is typically used. Basically, however, material webs of other types can also be processed according to the principle illustrated in FIG. 1, such as webs 1 of paper, cardboard, plastic, metal, or composites and/or combinations of these materials.

FIG. 2 shows a typical section of the web material 1 provided for the production of a container. It is possible to see, first, the weakened lines 5 of material, which have already been indicated in FIG. 1. In addition, separation lines 9 can be seen, along which the web material 1 is cut into individual blanks after the web material 1 has been folded into a tube-like shape and after the sealing seam 8 shown in FIG. 1 has been produced. In addition, transverse lines 10 can be seen, which, like the weakened lines 5, can be produced by folding, grooving, or perforation. Along the transverse lines 10, the blanks in question are folded in such a way that the future container will be given its bottom area and a top closure area.

FIG. 3 shows the part of the system which, in terms of process technology, processes the web material 1 first. The web material 1 is supplied to the machine in rolls 11. To facilitate continuous operation, two rolls 11 are arranged in the area of the payout unit 12, wherein one of the rolls 11 feeds the system with the web material 1 currently being processed, whereas the second roll 11 makes it possible for production to continue without interruption after the first roll 11 has been used up. As soon as the first roll 11 is used up, it can be replaced by a new roll 11.

In the area of the rolls 11, the web material 1 is typically in an already coated and printed state. When it is necessary to switch the feed of the web material from the first roll 11 to the second roll 11, the leading edge of the new roll 11 is joined to the trailing edge of the old roll 11 inside a joining station 13. This can be done, for example, by the use of adhesive tape.

Because of the comparatively heavy weight of the rolls 11 and of the overall payout unit 12, controlling or regulating the transport speed of the web material 1 by acting on the payout unit 12 does not produce results quickly enough. Instead of that, at least one compensator roll 14 is used, which, with its low mass inertia, can hold the differences in web tension of the web material 1 resulting from roll replacement constant.

At least one tensioning roll 15 is used to maintain a defined tension within the web material 1. In addition, a brake mechanism is provided in the area of the payout unit 12.

The cooperation between the brake device and the tensioning roll 15 makes it possible to maintain the desired web tension.

A control sensor 16 makes concrete length data available concerning the web material 1. With the use of the control sensor 16 or of a plurality of control sensors 16, it is possible to detect differences in the length of the web material 1 and to compensate for these length differences by changing the position of the web relative to the following tools by suitable actuation of the tensioning roll 15 and thus by means of a change in the tension of the web.

The web tension produced by the use of the tensioning roll 15 can be detected by a web tension sensor 17. According to the exemplary embodiment shown here, several tensioning rolls 15 are used to produce the tension.

In one embodiment of the joining operation, already mentioned above, by which the trailing end of the paid-out roll 11 is joined to the leading end of the new roll 11, it is usually necessary, when making this edge-to-edge joining, to cause the web material 1 to come to a halt in the area of the joining station 13 to allow the joining operation to be performed. So that this idle state does not interrupt production, a roll buffer 18 is used. The roll buffer 18 contains a plurality of rolls, over which the web material 1 is guided. The buffering length of the roll buffer 18 is changed by changing the distances between the various rolls. By moving the rolls closer together, therefore, it is possible to continue to supply the downstream system with the web material 1 even after the web has been stopped in the area of the joining station 13. The roll buffer 18 can be filled back up again by paying out the web more quickly for a certain period of time in the area of the payout unit 12. In other methods for replacing the rolls, it is possible to eliminate the need for bringing the web to a stop and thus to eliminate the need for the roll buffer 18.

After leaving the roll buffer 18, the web material 1 is first sent to a prebreaking station 19. The use of this prebreaking station 19 is advisable, because storing the web material 1 on the rolls 11 has the effect of aligning the fibers of the cardboard layers in such a way that a curvature is produced. The prebreaking step can eliminate this undesirable effect or at least minimize it.

The prebreaking in the area of the prebreaking station 19 is typically conducted in that, in the area of the prebreaking station 19, the web material is deflected around a short, bending radius in the direction opposite the payout direction. This can be accomplished with the use of a roll provided with a small diameter and by guiding the web around it in the direction opposite the payout direction. By changing the prebreaking angle in the prebreaking station 19, it is possible to adapt the resulting prebreaking moment continuously to the current diameter of the roll 11. An appropriate control unit is provided for this purpose.

Downstream from the prebreaking station 19, a lateral web edge control system 20 is positioned. This lateral web edge control system 20 corrects any displacement of the web transversely to the longitudinal direction, which can occur, for example, as a result of the joining of the ends of the web when it is necessary to change over from one roll 11 to another roll 11.

A laser 21 can be used to produce perforations in the web material 1; these perforations have the function of making it easier to open the container after it has passed through all of the steps of the process. It is also possible to produce such perforations by means of a mechanical perforating tool 22. A grooving tool 23 is used to produce the transverse lines 10 shown in FIG. 2 as creases for the folds. Depending on the design of the package to be produced later, the grooving tool 23 can also be used to produce creases extending on a diagonal to the longitudinal direction of the web.

The weakened lines 5 of material extending in the longitudinal direction shown in FIG. 2 are produced by a longitudinal grooving tool 24.

When webs of material 1 which have already been printed are being stored in the area of the rolls 11, it is mandatory that the structures produced in the material by the perforation tool 22 and the grooving tool 23 be positioned correctly relative to the printing. To guarantee that these two elements are in exactly the right positions with respect to each other, the control sensor 16 typically detects a printing mark, applied by a printing machine when the web material 1 was printed. This printing mark serves as a control reference for the following work steps and makes it possible to adjust the positions of the structures relative to the printing. In correspondence with the position of the printing mark detected by the control sensor 16, the machine control unit, under consideration of the measurement values supplied by web tension sensors 17, actuates the tensioning rolls 15 and the tools 22, 23 or the laser 21 as needed.

According to an alternative embodiment, it is also possible to produce the grooves and/or the longitudinal grooves and/or the perforations extending transversely or diagonally even before the web material 1 is wound onto the rolls 11 and to keep webs prepared in this way on the rolls in the area of the payout unit 12. The concrete manner in which the process is implemented depends here on the local conditions, on the concrete production requirements, and on the design of the specific product.

After leaving the part of the system shown in FIG. 3, the appropriately pretreated web material 1 is sent to the part of the system shown in FIG. 4. The web material 1 arrives here first in the area of a longitudinal cutter 25, which cuts the web material 1 into narrower individual webs. This step of the process is necessary, because typically several blanks of the type shown in FIG. 2 are created next to each other transversely to the longitudinal direction of the web. The longitudinal cutter 25 typically divides the web material 1 into individual webs, each of which has the width shown in FIG. 2. Rotating cutting knives, for example, can be arranged in the area of the cutter 25.

In the case of a web of typical dimensions for the production of packaging of laminated material, four blanks according to FIG. 2 are present next to each other in the starting material. The web material 1 is therefore divided into four individual webs; in addition, edge strips are also typically cut off on the right and on the left. The edge sections can be carried away by a suction unit 26. A monitoring device 27 detects and monitors the positions of all the grooves and perforations which have been produced relative to the previously mentioned printing mark, and, if desired, it sends the data to a measurement data storage unit. If any deviations are detected, the machine control unit gives commands to the lateral web edge control system 20 and/or to the tensioning rolls 15.

In the area of a peeling station 28, preparatory measures for the production of the sealing seam 8 illustrated in FIG. 1 are carried out, wherein these preparatory measures involve the mechanical treatment of the web material 1. According to a typical embodiment, these preparatory mechanical measures involve peeling, grooving, folding over, and pressing. A process implementation of this type facilitates in particular the production of an aseptic seam edge, which is protected by an inner layer of polyethylene of the web material 1.

In the area of the peeling station 28, the individual webs produced by the longitudinal cutter 25—four individual webs in the embodiment shown here—are first sent to a web edge aligner 29. Here the individual webs are aligned transversely to the longitudinal direction. Then a strip of polyethylene and cardboard is peeled off along one of the edges of each of the individual webs by a peeling station 30. The narrow peeled edge strip thus obtained on the individual web is grooved in the middle by a grooving device 31 and folded over by 180° along this grooved edge by a fold-over mechanism 32. In conclusion, the folded-over seam is then pressed down by the use of a pressing device 33.

Downstream from the peeling station 28, a monitoring device 34 is installed, which detects the dimensions of the folded-over seam and, if desired, stores this information in the measurement data storage unit. As a function of the actual measurement results obtained by the monitoring device 34, the web edge aligner 29 corrects the positioning.

As an alternative to the production of a narrow, folded-over seam explained above, it is also possible to use a strip of polyethylene in the appropriate area. It is also possible to seal the exposed cardboard edges. Another variant involves the use of an adhesive.

Downstream of the monitoring device 34, a tension sensor 35 is installed, which measures the web tension in front of a tensioning roll 36. Downstream of the tensioning roll 36, a prefolding station 37 is installed. The prefolding station 37 serves to prebreak and to press the weakened lines 5 of material shown in FIG. 2, which are typically formed as longitudinal grooves. For this purpose, the material webs are transported through a forming device 38 and then sent to a pressing station 39. Downstream of the pressing station 39, an unfolding station 40 is positioned, which, after the completion of the preforming and prefolding steps, unfolds the web material again and thus returns it to a flat web-like shape.

The web material is now sent to one or more activation stations 42. This is preferably done directly, but, according to the embodiment illustrated in FIG. 4, it can also be done after the web has been guided around another tensioning roll 41. In the area of the activation station 42, the individual strip-shaped webs are heated along both edges of the web. Heating can be accomplished with hot air, for example, and/or by a treatment with plasma or by induction and/or by a gas flame. The choice of thermal source and the power output of the selected thermal source will be adapted to the speed of the web in question. The adaptation can be accomplished, for example, by turning on the individual activation stations 42 in a cascade-like manner. It is also possible to vary the power output of an individual activation station or of all of the stations. Through the combination of the previously described measures, it is possible in particular to implement an energy ramp-up.

Downstream of the activation station 42 with respect to the transport direction of the web material 1, tensioning rolls 43 and an additional tension sensor 44 for detecting the local web tension are installed. A concluding treatment of the web material 1 is carried out in the area of the finish-folding station 45. The finish-folding station 45 serves essentially to transform the flat web material 1 into the folded, tube-like state and to produce the sealing seam 8.

The material webs are aligned first by a web edge control system 46. Then, in the area of a forming station 47, the material is folded over along the weakened lines 5 of material shown in FIG. 2 by the use of the guide elements 2 shown in FIG. 1. The narrow folded-over seam thus obtained is first held in place by a finger 48 before the two edges of the web are joined by the sealing seam 8. Now that the two folded-over seams are being held in place, the two previously heated web edges can be pressed together by the pressing rolls 49. As a result of this pressing step, the heated areas of polyethylene on the two outer tabs are welded together to provide a nonpositive connection.

After this joining operation has been completed, only the two outlying grooves of the previously produced packaging tube are pressed in the pressing station 50 to ensure that the casing-like contour of the packaging blank will spring open during later use. The heated strip is cooled by the use of cooling rolls 51.

A quality detector 52 is installed between the pressing rolls 49 and the cooling rolls 51 in the transport direction of the web material 1. The quality detector 52 determines the position and the dimensions of the sealing seam 8 by the use of appropriate sensors and stores this measurement information in the measurement data storage unit. The quality detector 52 is connected to the web edge control system 46 by way of an assigned control unit so that adjustments can be carried out automatically.

Tensioning rolls 53 or tensioning belts and a cross-cutter 54 are installed downstream from the cooling rolls 51 with respect to the transport direction of the web material 1. The cross-cutter 54 is typically equipped with transverse knives. It is especially preferred to use rotating knives for this purpose. The cross-cutter device 54 cuts the tube-like folded web material along the separation lines 9 shown in FIG. 2. The previously mentioned packaging casings are obtained as individual blanks. The individual blanks are carried away by the take-off rolls 55 or belt guides from the area of the cross-cutter 54.

Before the cross-cutter 54 is used to perform the cutting operation, it is necessary to ensure the correct longitudinal alignment of the tube-like folded web material to be cut with the knives to be used. This alignment can again be accomplished by the use of the control mark applied during the printing step. It is also possible to evaluate the position of one or more grooved lines. A sensor 56 detects the position of this control mark or other markings and makes the measurement information available to a control unit for the drive of the cross-cutter 54. The drive is automatically controlled as appropriate to ensure that the lengths of the individual blanks and the position of the cuts which are produced relative to the printed mark remain within predefined tolerance ranges.

According to an especially effective idea, separate cross-cutters 54 and tensioning rolls 53 are used for each of the individual webs produced by the longitudinal cutter 25.

Through the use of an election station 57, it is possible to sort out defective packaging casings on the basis of the measurement data provided by the quality detector 52 or, if the quality requirements are satisfied, to transport the casings further onward.

Packaging casings of a quality within the predefined tolerance spectrum are stacked on top of each other like fish scales by a stacking station 58 and deposited in several rows in a fish scale-like manner. The stacks of packaging casings thus obtained are carried away by a conveyor device 59, typically in the form of a conveyor belt.

FIG. 5 shows the final part of the system with the conveyor device 59 and a packing machine 60, in which the stacked package casings are packed into outer cartons. Typically each of these outer cartons contains approximately 300 package casings.

FIGS. 6-9 show a first design variant for implementing the forming device 38 in the area of the prefolding station 37. To supply the web material 1, the forming device 38 comprises deflecting rolls, on which the web to be formed rests. A defined web tension is produced by the use of tensioning rolls, which are arranged upstream of the deflecting rolls in question and downstream of the pressing station 39. With the use of a web edge sensor, the position of the web is measured, and the information thus obtained is sent to the assigned machine control unit. The machine control unit automatically controls the deflecting rolls in such a way that the web is kept in the preset radial position. According to a simple embodiment, the deflecting rolls are cylindrical. It is also possible, however, to use a crowned roll contour.

The web, which extends essentially horizontally at first, can be sent over rolls which are set at angle to the linear formations produced in order to compensate for the resulting twist. In this way it is possible to orient the edges of the web properly for the production of the longitudinal seams. The positioning and the slanting of the rolls just mentioned are preferably controlled automatically by the machine control unit. The angle which represents the optimum value at the time in question depends on the concrete length relationships of the web tabs to be folded over.

FIG. 6 shows that the web material 1 is subjected to a first forming step by a first forming element 61. A support roll 62, as previously mentioned, is arranged at an angle to the horizontal direction. Lateral guidance is provided by conical rolls 63. The web material 1 is thus bent over along the longitudinal grooves 64.

In the area of their predefined guide profiles, the conical rolls 63 guide the web material 1 with precision along the area of the longitudinal grooves 64 and thus provide a stop function. Pressure which pushes the web material against the support rolls 62 is provided by a pressing device 66, which is equipped with pressing rolls 67.

FIG. 7 shows a second forming element 68 of the forming device 38. Here, too, a setting angle 65 relative to the horizontal direction is present.

The second forming element 68 comprises lower rolls 69 and upper rolls 70. The upper rolls 70, for example, can each be driven separately, so that an incorrect axial positioning of the web edges relative to each other—possibly detected by the use of sensors—can be corrected by operating the upper rolls 70 at different speeds as determined by the machine control unit.

The second forming element 68 serves essentially to form the tabs and to keep the web centered so that the longitudinal grooves 64 which it forms are straight.

The straight longitudinal grooves 64 formed by the second forming element 68 are pressed in the area of the pressing station 39 shown in FIG. 8. The distance between the pressing rolls 71 of the pressing station 39 relative to each other is adjustable so that the breaking of the cardboard fibers can be varied.

FIG. 8 shows that the use of the pressing station 39 and the use of the second forming element 68 are carried out with an offset. This makes it possible to fold over and to press the short tab first in an extremely space-saving manner and then to fold the large tab over onto the small tab and to press it down.

FIG. 9 shows a local application, in which the web material 1 is treated in the area of the longitudinal groove 64 only by the two pressing rolls 71 of the pressing station 39.

FIGS. 10-13 show a first design variant for implementation of the finish-folding station 45. FIG. 10 show a first forming element 72, the setting angle 73 of which is oriented at a slant to the horizontal direction. As in the case of the first forming element 61 of the prefolding station 37, the web material 1 is formed by the use of conical rolls 74 in such a way that the longitudinal grooves 75 are made straight. A pressing device 76 with pressing rolls 77 pushes the web material 1 against a transverse roll 78, which connects the conical rolls 74 to each other.

The second forming element 79 of the finish-folding station 45 shown in FIG. 11 also has a setting angle 73 which is oriented at a slant to the horizontal direction. As also in the case of the prefolding step according to FIG. 7, folding is carried out here with the use of lower rolls 80 and upper rolls 81. The folded-over seam 82 with the associated tab is thus guided downward.

FIG. 12 shows a preparatory step for the production of the sealing seam 8 illustrated in FIG. 13. For this purpose, a third forming element 83 pivots the associated tab downward around the longitudinal groove 75. A guide element 84 in the area of the third forming element 83 holds the folded-over seam 82 shown in FIG. 11 in place, so that it can be joined in parallel fashion to the opposite tab of the blank. The guide element 84 can, for example, be designed as a finger or as a small roller track. According to an alternative embodiment, the folded-over seam 82 is already being held in place, after the completion of the peeling and folding-over steps, by the application of an adhesive during the performance of the pressing step. When this variant of the process is used, the guide element 84 can be omitted.

FIG. 13 illustrates the concluding process step, in which the tab shown on the right in the drawing is laid onto the folded-over seam 82 produced in the peeling station 28, and the tab and the seam are then welded together by a sealing roll 85. As a result, the previously activated areas of polyethylene of the material flow into each other and produce the sealing seam 8. The sealing seam 8 has aseptic properties.

FIGS. 14-16 show a second design variant of the finish-folding station 45. In this embodiment, the first forming element 72 of the finish-folding station 45 produces an essentially elliptical hollow profile. The setting angle 73 of the first forming element 72 is again oriented at a slant to the horizontal direction. In addition to the conical rolls 74, the tabs of the web material 1 are laid over each other in the edge area, wherein the tab with the folded-over seam 82 is arranged on the inside. The web material 1 is also guided by inner guide rolls 86, so that the longitudinal grooves 75 to be pressed rest in each case in the creasing profiles of the conical rolls 74.

FIG. 15 shows a following production step, in which, by the use of an inner guide device 87, the facing tabs are brought together in the area of the folded-over seam 82. In addition, as also in the case of the embodiment according to FIG. 12, an additional guide device 88 can be used.

FIG. 16 shows a modification of the sealing station 89 according to FIG. 13. Here, two sealing rolls 90 are used, which are arranged opposite each other.

1-15. (canceled)

16. A method for producing container-like laminated packagings, comprising the steps of: folding a web material consisting of a laminate, which contains at least one layer of cardboard and at least one layer of a plastic; providing the web material with a sealing seam; and cutting the web material into individual sections suitable for forming a desired type of a container, wherein the sealing seam is produced before the web material is cut into individual sections.

17. The method according to claim 16, including grooving the web material to form fold lines.

18. The method according to claim 16, including folding the web material.

19. The method according to claim 16, wherein a cross section selected from the group consisting of essentially rectangular, round, rounded, elliptical, polygonal with sharp corners, and polygonal with rounded corners.

20. The method according to claim 16, including providing the sealing seam by melting certain plastic areas of the container-like material.

21. The method according to claim 16, including providing the sealing seam after the web material has been folded and after the folded structure is collapsed into a flat, tube-like formation.

22. The method according to claim 16, including providing the sealing seam after the web material is folded around an interior space.

23. The method according to claim 16, including producing the sealing seam aseptically.

24. A device for producing container-like laminated packagings, comprising: a transport mechanism for a web material consisting of a laminate containing at least one layer of cardboard and at least one layer of a plastic; at least one folding mechanism for folding the web material; at least one one separating mechanism for dividing the web material into individual sections suitable for obtaining a desired type of container, wherein the sealing mechanism is arranged upstream of the separating mechanism with respect to a transport direction of the web material.

25. The device according to claim 24, further comprising a grooving mechanism for putting a groove in the web material.

26. The device according to claim 24, comprising a folding mechanism for the web material.

27. The device according to claim 24, wherein the folding mechanism is operative to fold the web material for a container with a cross section selected from the group consisting of essentially rectangular, round, rounded, elliptical, polygonal with sharp corners, and polygonal with rounded corners.

28. The device according to claim 24, wherein the sealing mechanism is operative to melt plastics.

29. The device according to claim 24, wherein the sealing mechanism is operative to treat an essentially

30. The device according to claim 24, wherein the sealing mechanism is operative to treat a 3-dimensional structure that encloses an interior space.
